(19) United States
(12) Patent Application Publication
(10) Pub. No.: US 2007/0026945 A1
(43) Pub. Date: Feb. 1, 2007

(54) Enhancing the game console experience through the PC

(75) Inventor: Vu Nguyen, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/192,537

(22) Filed: Jul. 29, 2005

(51) Int. Cl. A63F 13/00

(52) U.S. Cl. 463/42; 463/1; 463/43

(57) ABSTRACT

A game console and a multipurpose computer connected over a network may share information regarding their available resources and capabilities. These resources and capabilities may then be shared between the multipurpose computer and the game console. For example, the game console may leverage some of the processing power and spare storage on the multipurpose computer in order to enhance game play on the game console. Moreover, it may also be possible to control aspects of the game console from the multipurpose computer, thereby allowing a single game to be played simultaneously by both a user at the game console and a user at a multipurpose computer.

### BACKGROUND

Game consoles have traditionally been created as stand alone devices for running game titles. This functionality has been broadened by modern game consoles, however, which allow for interaction among several game consoles, thus permitting the inclusion of more players into a game environment.

In addition, personal computers enjoy wide acceptance among the general public, with many households and businesses currently implementing local networks for the purpose of connecting various electrical devices. Often these networks are facilitated by employing a media compatible personal computer (PC) as an entertainment server in order to access and deliver media content over a network to client devices such as a desktop PCs, notebooks, portable computers, cellular telephones, other wireless communications devices, personal digital assistants (PDA), IP set-top boxes, and handheld PCs. Software, such as the WINDOWS XP® Media Center Edition operating system marketed by the Microsoft Corporation of Redmond, Wash., has greatly reduced the effort and cost required to transform normal home PCs into hosts capable of delivering content and communicating with such client devices.

Many consumers own both game consoles and entertainment servers. This trend can be expected to grow considerably as the sophistication of consumers increases, and as game consoles and entertainment servers are engineered to be easier to set up and use.

### SUMMARY

A game console and a multipurpose computer connected over a network may share information regarding their available resources and capabilities. These resources and capabilities may then be shared between the multipurpose computer and the game console. For example, the game console may leverage some of the processing power and spare storage on the multipurpose computer in order to enhance game play on the game console. Moreover, it may also be possible to control aspects of the game console from the multipurpose computer, thereby allowing a single game to be played simultaneously by both a user at the game console and a user at a multipurpose computer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an exemplary home environment including a multipurpose computer, a game console, and a home television.

FIG. 2 illustrates a block diagram of the interaction program code being used in conjunction with a multipurpose computer communicatively coupled to a game console.

FIG. 3 is a flow diagram illustrating a method for using interaction program code to enable the game console and the multipurpose computer to share resources and capabilities.

FIG. 4 is a flow diagram illustrating a method for allowing a user on the multipurpose computer to engage in game play on the game console.

FIG. 5 is a flow diagram illustrating a method for allowing a user on the game console to leverage the resources and capabilities of the multipurpose computer.

FIG. 6 is a flow diagram illustrating a method for allowing a user on the multipurpose computer to manipulate the game console.

### DETAILED DESCRIPTION

### Home Environment

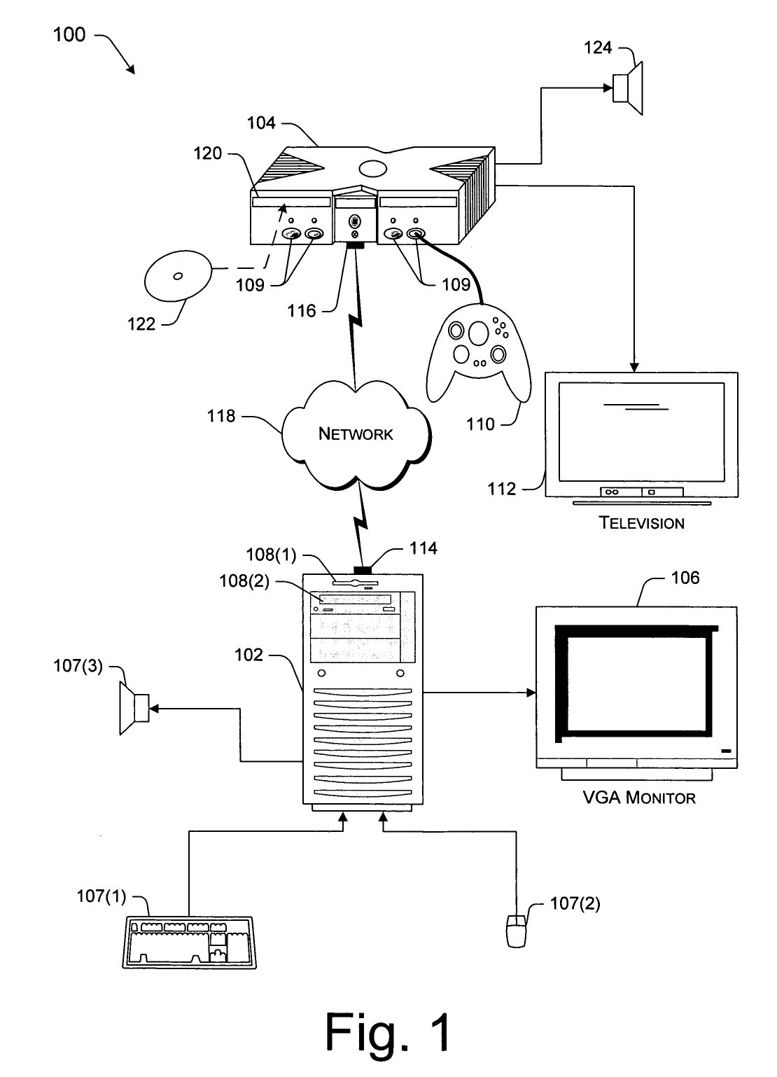

FIG. 1 shows an exemplary environment 100 in which the techniques described herein can be implemented. Environment 100 comprises a multipurpose computer 102 and a game console 104. The multipurpose computer 102 is a personal computer (PC) having conventional user interface components such as a graphics display or monitor 106, a keyboard 107(1), a mouse or other pointing device 107(2), and speakers 107(3). Computer 102 in this embodiment is configured to run under a graphical operating system such as one of the Windows® family of operating systems marketed by the Microsoft Corporation.

In the example described herein, computer 102 is a desktop computer. However, it could alternately comprise a variety of other types of computer and computer-like devices, such as a notebook or portable computer, a tablet PC, a personal digital assistant (PDA), a workstation, a mainframe computer, a server, an Internet appliance, a set-top box, combinations thereof, and so on.

Generally, a computer such as the one shown in FIG. 1 will have various functionality, allowing a user to perform many different tasks. For example, a user will typically be able to run a host of standard computer programs (word processing, spreadsheets, etc.) and games, send and receive emails, browse the Internet, etc. A user typically interacts with a computer such as this by moving an on-screen cursor with the mouse 107(2), and by typing at the keyboard 107(1).

Computer 102 may also include various types of data storage mechanisms, in this case comprising a hard disk, and one or more removable media drives 108.

Game console 104 is a device that is generally designed primarily for gaming. As a result, its user interface elements are designed to optimize game playing and often do not include input/output devices that might be used for more general types of tasks. In particular, game console 104 in this example has a plurality of ports 109 for game controllers, one of which is shown in FIG. 1 as game controller 110. A game controller 110 is typically a handheld device operable by a user. Normally, game controllers 110 have a limited number of buttons and other actuators that are related by game programs primarily to media content such as graphically displayed game elements and game play options. Such controllers typically do not include alphanumeric keyboards, because it is seldom necessary to input textual information during game play.

Another typical characteristic of a game console is that it is often designed to work with a television as its graphics display. In this example, the graphics display of game console 104 is depicted as a television 112. Game consoles are generally considered by consumers to be entertainment devices rather than computing devices, and are therefore designed to be integrated into home entertainment systems: hence, the typical use of an existing television or television monitor rather than a dedicated computer monitor.

The particular game console illustrated in FIG. 1 is an Xbox® game system marketed by the Microsoft Corporation. Of course there can be many different types and configurations of games consoles, not limited to the specific example of FIG. 1.

Both computer 102 and game console 104 have communications ports 114, 116, respectively, configured to allow computer 102 and game console 104 to communicate with each other. Such communications ports might comprise network ports that connect to some type of local area or wide-area network, and/or to the Internet. Such a network is designated in FIG. 1 by reference numeral 118. Other types of communications media might alternatively be used, including both wired and wireless technologies. In the example of FIG. 1, communications is by way of Ethernet communications media, utilizing conventional protocols such as transmission control protocol (TCP), Internet protocol (IP), and others.

The game console 104 typically has a small form factor and is equipped with an internal hard disk drive (not shown) and an optical disk drive 120 that supports various forms of removable, non-volatile optical storage disks 122, such as a CD-ROMs, DVD-ROMs, game disks, game cartridges, and other media. Games are typically distributed on such media, although they can also be downloaded using the network connectivity of the game console 104.

The game console 104 is configured to render various rich audio and video media experiences that are typically associated with modern video games. These media experiences may be rendered on the television 112 as well as speakers 124. User controllers 110 are operated by users or players in order to manipulate displayed graphical elements.

The primary purpose of the game console 104 is to play video games, though the game console 104 may also be used to render audio and video content such as music and movies. With the different storage offerings, titles can be played from the hard disk drive or the storage disk 122 in drive 120, or from an online source. A sample of what the game console 104 is capable of playing back includes:
Game titles played from CD and DVD disks 122, or from the hard disk drive.
Digital music played from a CD 122 in the optical disk drive 120, or from a file on the hard disk drive (e.g., Windows Media Audio (WMA) format).
Digital audio/video played from a DVD disk 122 in optical disk drive 120, or from a file on the hard disk drive (e.g., Active Streaming Format).

In FIG. 1, only a single game console 104 is shown. It will be understood, however, that a plurality of game consoles 104 and corresponding displays 106, 112 may be used together, with the game consoles 104 potentially being communicatively coupled to each other and to the multipurpose computer 102. Similarly, a single system might include a plurality of multipurpose computers 102 configured for communication with each other and with one or more game consoles 104. Other types of devices might also be present on the communications network, such as printers and other peripheral devices.

### Game Console and Multipurpose Computer System Configured with Interaction Code

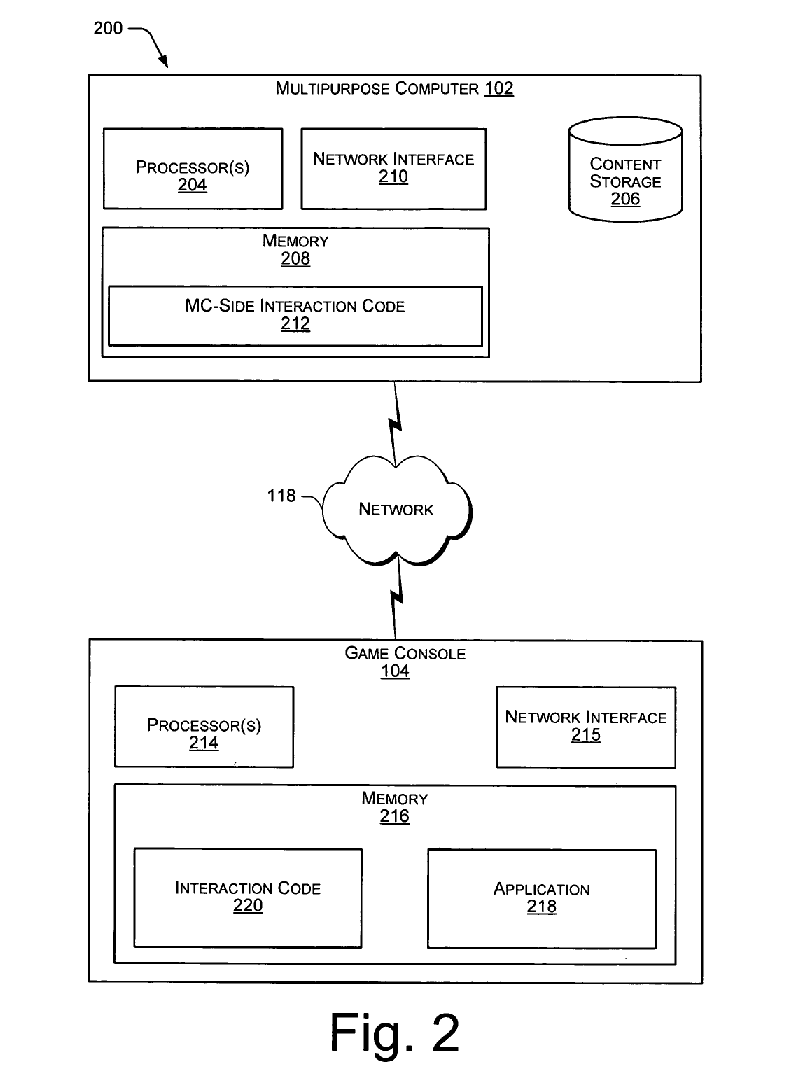

FIG. 2 illustrates relevant functional components of game console 104 and computer 102, which allow game console 104 to leverage the capabilities of the multipurpose computer 102 through use of interaction program code. In one implementation, the interaction program code may allow the game console 104 to enhance game play of a game title being played on the game console 104 by using the resources and capabilities of the multipurpose computer 102.

The multipurpose computer 102 may include one or more processors 204, a content storage 206, memory 208, and one or more network interfaces 210. Media content either processed and/or received (from another source) may be stored in the content storage 206. FIG. 2 shows the content storage 206 as being separate from memory 208. It will be understood, however, that content storage 206 may also be part of memory 208.

Memory 208 stores programs executed on the processor(s) 204 and data generated during their execution. Memory 208 may include various computer-readable storage media, such as volatile media, non-volatile media, removable media, and non-removable media. It will be understood that volatile memory may include media such as random access memory (RAM), and non volatile memory may include read only memory (ROM). The multipurpose computer 102 may also include other removable/non-removable, volatile/non-volatile computer storage media such as a hard disk drive for reading from and writing to a non-removable, non-volatile magnetic media, a magnetic disk drive 108(1) for reading from and writing to a removable, non-volatile magnetic disk (e.g., a “floppy disk”), and an optical disk drive 110 for reading from and/or writing to a removable, non-volatile optical disk such as a CD-ROM, DVD-ROM, or other optical media. The disk drives 108 and their associated computer-readable media provide non-volatile storage of computer readable instructions, data structures, program modules, and other data for the multipurpose computer 102.

In addition to including a hard disk, a removable magnetic disk, and a removable optical disk, as discussed above, the memory 208 may also include other types of computer-readable media, which may store data that is accessible by a computer, such as magnetic cassettes or other magnetic storage devices, flash memory cards, electrically erasable programmable read-only memory (EEPROM), and the like. The hard disk drive, magnetic disk drive 108(1), and optical disk drive 108(2) may each be connected to a system bus by one or more data media interfaces. Alternatively, the hard disk drive, magnetic disk drive 108(1), and optical disk drive 108(2) may be connected to the system bus by one or more interfaces.

Any number of programs, program modules, data objects, or other data structures may be stored on the memory 208 including an operating system, one or more application programs, other program modules, and program data.

In this example, memory 208 stores MC-side interaction code 212, which when executed on processor(s) 204, allows for communication and sharing of resources, capabilities, data and commands between the multipurpose computer 102 and the game console 104 over network 118.

The network interface(s) 210 may enable the multipurpose computer 102 to send and receive commands and media content among a multitude of electric devices communicatively coupled to the network 118. For example, in the event both the multipurpose computer 102 and the game console 104 are connected to the network 118, the network interface(s) 210 may be used to communicate a wide range of data, instructions, and commands between the game console 104 and multipurpose computer 102, allowing both devices to share resources and capabilities. In this way media content can be delivered between the game console 104 and the multipurpose computer 102 in real-time with full media transport functionality (i.e. users at the game console 104 and/or the multipurpose computer 102 may be afforded functions such as pause, play, fast forward, rewind, etc., along with full gameplay functionality including stop, jump, shoot, view left, view right, crouch, etc.).

Data, instructions, and commands received and sent by the network interface 210, are communicated between the game console 104 and the multipurpose computer 102 via network 118.

A user may enter commands and information into the multipurpose computer 102 via input devices such as a keyboard 107(1), pointing device (e.g., a “mouse”) 107(2), microphone, joystick, game pad, satellite dish, serial port, scanner, and/or the like. These and other input devices may be connected to the one or more processors 204 via input/output interfaces that are coupled to the system bus. Additionally, they may also be connected by other interface and bus structures, such as a parallel port, game port, universal serial bus (USB) or any other connection included in the network interface 210.

In a networked environment, program modules depicted and discussed above in conjunction with the multipurpose computer 102 or portions thereof, may be stored in a remote memory storage device. By way of example, remote application programs may reside on a memory device of a remote computer communicatively coupled to network 118. For purposes of illustration, application programs and other executable program components—such as the operating system and the MC-side interaction code 212—may reside at various times in different storage components of the multipurpose computer 102, the game console 104, or of a remote computer, and may be executed by one of the at least one processors 204 of the multipurpose computer 102, or by processors on the game console 104 or the remote computer.

The exemplary game console 104 may include one or more processors 214, one or more network interfaces 215, and memory 216. The network interface(s) 215 may enable the game console 104 to send and receive commands and media content among a multitude of electric devices communicatively coupled to the network 118. Referencing the example from above, in the event both the multipurpose computer 102 and the game console 104 are connected to the network 118, the network interface(s) 210, 215 may be used to communicate a wide range of data, instructions, and commands between the game console 104 and multipurpose computer 102, allowing both devices to share resources and capabilities.

Memory 216 may include computer-readable media such as volatile media, non-volatile media, removable media, and non-removable media. It will be understood that volatile memory may include computer-readable media such as random access memory (RAM), and non volatile memory may include read only memory (ROM). A basic input/output system (BIOS), containing the basic routines that help to transfer information between elements within the game console 104, such as during start-up, may also be stored in ROM. RAM typically contains data and/or program modules that are immediately accessible to and/or presently operated on by the one or more processors 214.

The game console 104 may also include other removable/non-removable, volatile/non-volatile computer storage media such as a hard disk drive for reading from and writing to a non-removable, non-volatile magnetic media, portable storage devices such as USB flash drives, or dongles, and an optical disk drive 120 for reading from and/or writing to a removable, non-volatile optical disk 122 such as a CD-ROM, DVD-ROM, or other optical media. The memory 216 may also include other types of computer-readable media, which may store data that is accessible by a computer, like other magnetic storage devices, flash memory cards, electrically erasable programmable read-only memory (EEPROM), and the like.

The hard disk drive, portable storage devices, and the optical disk drive 120 may be each connected to a system bus by one or more data media interfaces. Alternatively, the hard disk drive, portable storage devices, and the optical disk drive 120 may be connected to the system bus by one or more interfaces.

The disk drive 120 and its associated computer-readable media provide non-volatile storage of computer readable instructions, data structures, program modules, and other data for the game console 104. Any number of program modules may be stored on the memory 216 including, by way of example, an operating system, one or more application programs 218, other program modules, and program data. One such application could be interaction code 220, which when executed on processor(s) 214, could interact with the MC-side interaction code 212 on the multipurpose computer 102 and allow for communication and sharing of resources, data, and commands between the game console 104 and the multipurpose computer 102 over network 118. The interaction code 202 may also present the user with a graphic interface complementing the application(s) 218, or game titles being played at the game console 104.

It will be understood that the interaction code 220 may be loaded onto the game console 104 by the manufacturer, or by another entity in the distribution channel from the manufacturer to the consumer. For example, the interaction code 220 may be burned into ROM inside the game console 104, or the interaction code 220 may be included in an operating system or other application installed on the game console 104. Alternately, the interaction code 220 could be loaded from another device in communication with network 113.

In a similar manner, the MC-side interaction code 212 on the multipurpose computer 102 may be burned into ROM inside multipurpose computer 102 or included as part of an operating system on the multipurpose computer 102, or as a separate application.

Alternately, the MC-side interaction code 212 may be received by the multipurpose computer 102 from the game console 104 over the network 118. In such an implementation, a portion of boot strap code present on the multipurpose computer 102 could interact with the game console 104 and assist in the transfer of the MC-side interaction code 212 from the game console 104 to the multipurpose computer 102.

In another possible implementation, a game title on an optical disk could include the MC-side interaction code 212 which could then be delivered to the multipurpose computer 102 by the game console 104 over the network 118 through use of boot strap code on the multipurpose computer 102. Similarly, the MC-side interaction code 212 could be delivered to the multipurpose computer 102 via portable computer-readable media, for example an optical storage disk placed in the optical disk drive 108(2) of the multipurpose computer 102. In one aspect, game titles intended for the game console 104 could also include an optical storage disk for use with the multipurpose computer 102. The optical storage disk could contain the MC-side interaction code 212, or a code enabling or unlocking MC-side interaction code 212 already residing on the multipurpose computer 102. Alternately, the MC-side interaction code 212 could be received from a website or other source via the Internet.

It will also be understood that the MC-side interaction code 212 may be configured to work with all game titles played on the game console 104, or the MC-side interaction code 212 may be designed to function only with specific game titles played on the game console 104. In such an instance, a different version of the MC-side interaction code 212 could be required for each different game title desired to be played on the game console 104.

In operation, the interaction code 220 on the game console 104, and the MC-side interaction code 212 on the multipurpose computer 102 allow for communication between the game console 104 and the multipurpose computer 102 over network 118. This communication may include identification of the capabilities of both the game console 104 and the multipurpose computer 102, as well as the communication of commands, media content, and other data between the game console 104 and the multipurpose computer 102.

In order to prevent the game console 104 and multipurpose computer 102 from erroneously communicating with every device communicatively coupled to the network 118, binding may occur. Under this process, both the game console 104 and the multipurpose computer 102 may be provided with credentials, which may be verified in order to identify the game console 104 and the multipurpose computer 102 as correct parties to undergo an abstraction of resources. These credentials may include, for example, specific identities of the game console 104 and the multipurpose computer 102, specific identities of users on the game console 104 and the multipurpose computer 102, temporal secretes shared by the game console 104 and the multipurpose computer 102, and temporal secrets shared by users on the game console 104 and the multipurpose computer 102. Moreover, the credentials may be included within the MC-side interaction code 212 and the interaction code 220, or they may be input later by, for example, one or more users.

In one exemplary implementation, the game console 104 may issue a prompt to user(s) to enter a credential code (included in the prompt) to any device coupled to the network which the user(s) wishes to have interact with the game console 104. This credential code may then be entered into a prompt field rendered by the devices (including the multipurpose computer 102), binding the devices to the game console 104. Alternately, the game console 104 may display a list of devices connected to the network 118, and provide the user(s) the opportunity to select those devices which the user(s) wishes to have interact with the game console 104.

In yet another aspect, a prompt may be rendered by devices coupled to the network 118 asking a user interacting with the device if they wish for the device to interact with the game console 104. For example, the prompt might appear on the monitor 106 coupled to the multipurpose computer 102 telling the user that someone is playing a particular video game on the game console 104, and asking them if they would like to join the game from the multipurpose computer 102. On the game console 104, a corresponding prompt may give users the option of extending or declining to issue such an invitation.

Once the multipurpose computer 102 and the game console 104 are bound, the game console 104 and the multipurpose computer 102 can begin to communicate with each other.

For example, in one possible scenario a user playing a game title on the game console 104 may invite a user on the multipurpose computer 102 to join a game. Such an invitation may be accomplished through a series of prompts on both the game console 104 and multipurpose computer 102. In the event that the user on the multipurpose computer 102 accepts the invitation, the user on the multipurpose computer 102 may join in the game being run on the game console 104. For example, in one aspect, a user on the game console 104 may be a pilot of an aircraft, while the user on the multipurpose computer 102 may be a navigator or bombardier on the same aircraft. In such a scenario the user on the multipurpose computer 102 may interact with the game title being executed on the game console 104 through use of the monitor 106 along with the keyboard 107(1), the pointing device (e.g., a “mouse”) 107(2), a microphone, a joystick, a game pad, or a game controller at the multipurpose computer 102. Similarly, the user at the game console 104 may interact with the game title being run on the game console 104 using the television 112, along with the game controller 110 at the game console 104. The game title may include program code allowing the game title to interact with the interaction code 220 and the MC-side interaction 204, thus facilitating a smooth exchange of user and computer commands, and data between the multipurpose computer 102 and the game console 104.

In another possible implementation, the interaction code 220 and the MC-side interaction code 204 may facilitate resource sharing between the game console 104 and the multipurpose computer 102. For example, the MC-side interaction code 210 on the multipurpose computer 102 may create a report telling the game console 104 what kind of processor(s) 204 the multipurpose computer 102 has, including the operating speeds and other characteristics of the processor(s) 204. Similarly, the multipurpose computer 102 could report memory characteristics, such as the types, relative speeds, and amounts of memory 208 the multipurpose computer 102 possesses, along with how much memory is currently free for use. The multipurpose computer 102 could also relate information regarding the characteristics of a video card installed on the multipurpose computer 102, including the type of video card, along with the capabilities of the video card. Moreover, the multipurpose computer 102 could communicate to the game console 104 what type of network 118 the multipurpose computer 102 is coupled to, including the possible bandwidth available through the network 118, and the possible bandwidth of data that can be effectively handled by the video card and the network interface(s) 210, or processed by the multipurpose computer 102.

Other resources that the multipurpose computer 102 could report to the game console 104 include, for example, input and output devices available to the multipurpose computer 102, including displays, keyboards, game controllers, etc., that are, or could be, coupled to the multipurpose computer 102.

In a similar manner, the game console 104 may use the interaction code 220 to report all of its capabilities and resources to the multipurpose computer 102 via the network 118. Once the multipurpose computer 102 and the game console 104 have exchanged information regarding their available resources and capabilities, decisions can then be made as to how to best abstract those resources and capabilities to best leverage them. This may be done, for example, by the interaction code 220 residing on the game console 104. Alternately, the MC-side interaction code 212 or various other applications residing on the game console 104 and the multipurpose computer 102, may examine all of the reported resource and capability information from the multipurpose computer 102 and the game console 104 and decide how best to leverage the resources and capabilities to best enhance game play on the game console 104, and/or best enhance a user experience on the multipurpose computer 102. In yet another aspect, the interaction code 220 and the MC-side interaction code 212 may work together in determining how to best leverage and share the resources on the game console 104 and the multipurpose computer 102.

It will also be understood that resources and capabilities need not be reported by both the multipurpose computer 102 and the game console 104. For example, in one exemplary implementation, a report of the capabilities and resources of the multipurpose computer 102 may be generated so that the game console 104 may leverage these capabilities and resources. Alternately, in another exemplary implementation, a report of the capabilities and resources of the game console 104 may be generated so that the multipurpose computer 102 may leverage these capabilities and resources.

Once the level of possible sharing has been determined, transmission channels, such as channels for audio content, video content, and inputs and outputs may be established. These channels may be created using the lowest common denominators reported by the multipurpose computer 102 and the game console 104 regarding qualities such as acceptable bandwidth and processing speed in order to ensure a smooth flow of data and instructions through the various channels.

For example, if one of the bandwidth, available memory, display capabilities, or processing power or processing speed of the multipurpose computer 102 is inferior to a corresponding quality on the game console 104, then only a user experience which can be supported by the lesser resource on the multipurpose computer 102 may be delivered to the multipurpose computer 102 over the network 118. In some instances, this might mean that the user experience on the multipurpose computer 102 may be inferior to that experienced on the game console 104. This could manifest itself in the form of lower quality audio and visual renderings, or of more limited renderings by the multipurpose computer 102. In other scenarios, the resources and capabilities of the multipurpose computer 102 may be superior to those available on the game console 104, enabling the multipurpose computer 102 to render a richer user experience than that rendered by the game console 104.

Moreover, the characteristics of the network 118 itself may be considered. In some instances, a low bandwidth capacity of the network 118 may be the limiting factor in the interaction between the game console 104 and the multipurpose computer 102, preventing each from effectively sharing as many resources and capabilities as they have available.

Once the multipurpose computer 102 and the game console 104 have been bound, and appropriate resource and capability sharing levels have been established, the capabilities and resources of both the multipurpose computer 102 and the game console 104 may be leveraged. This can lead to an improvement of a user experience on both the game console 104 and the multipurpose computer 102, and can result in more efficient use of the resources and capabilities of the game console 104 and the multipurpose computer 102.

Returning to the pilot and bombardier game example above, by leveraging resources, the user experience of both the user at the multipurpose computer 102 and the user experience of the user at the game console 104 can be improved and enriched. For example, once the user on the multipurpose computer 102 and the user on the game console agree to play a game, resource and capability abstraction can proceed as described above in order to establish how many resources and capabilities the multipurpose computer 102 and game console 104 may share with each other. In addition, the resource and capabilities information of the game console 104, the multipurpose computer 102, and the network may be examined to see how large transmission channels may be made in order to transport input and output content, audio content, and video content between the game console 104 and the multipurpose computer 102 over the network 118. Once appropriate levels for sharing have been established, the user on the multipurpose computer 102 may join in the game being run on the game console 104.

The game title may include program code allowing the game title to interact with the interaction code 220 and the MC-side interaction 204, thus facilitating a smooth exchange of capabilities and data between the multipurpose computer 102 and the game console 104. In this way, both users may share some commonalities in their user experiences, while also enjoying some differences in their user experiences. For instance, the gamespace environment rendered at the game console 104 may be richer, and exhibit more variety than that shown to the navigator or bombardier at the multipurpose computer 102. In such a manner, inequities between available resources at the game console 104 and multipurpose computer 102, such as those discussed above, may be accommodated.

Overall, the functioning of the game console 104 can be enhanced through use of the functionality of the multipurpose computer 102. For example, the input devices coupled to the multipurpose computer 102 may be used to input commands to the game console 104.

In addition, a display coupled to the multipurpose computer 102 may be used to render output from the game console 104 (rather than requiring a split screen rendering at the game console 104 in order to include both users). In such an implementation, the MC-side interaction code 212 could utilize meta commands to facilitate the rendering of specific game experiences. Such use of meta commands could improve game play and ameliorate network bandwidth constraint concerns by lessening the flow of media content between the game console 104 and the multipurpose computer 102.

Moreover, memory 216 and processor(s) 214 on the multipurpose computer 102 may be used by the game console 104 to render a richer media experience to both users.

When the user at the game console 104 wishes to discontinue playing, he may quit his session. This may also generate a prompt to inform the user at the multipurpose computer 102 of the actions of the user at the game console 104. This may lead to the automatic expulsion of the user at the multipurpose computer 102 from the game title being played on the game console 104. Alternately, it would also be possible to allow the user at the multipurpose computer 102 to continue playing the game title being run on the game console 104 in the absence of the user at the game console 104. In such an instance, the user at the multipurpose computer 102, could use the input devices at the multipurpose computer 102 to manipulate the game console 104 to the same extent and degree which might be possible for a user at the game console 104.

In addition to playing cooperatively, the users on the game console 104 and the multipurpose computer 102 may also compete against one another head-to-head. In such a scenario the actions of each user, input using corresponding input devices at the multipurpose computer 102 and the game console 104, may be used to control each user's experience independently of the other user.

The sharing of resources enabled by the interaction code 220 on the game console 104, and the MC-side interaction code 212 on the multipurpose computer 102 may also be used to improve the game experience on the game console 104. For example, a user on the game console 104 may elect to utilize resources and capabilities on the multipurpose computer 102 while playing a game title on the game console 104. This may or may not be subject to permission granted by a user on the multipurpose computer 102. In such a scenario, the game console 104 could use resources such as memory and processing power on the multipurpose computer 102 in order to improve the user experience rendered at the game console 104. In a similar manner, this situation could be reversed, and a user at the multipurpose computer 102, could leverage resources on the game console 104 in order to improve a user experience being rendered at the multipurpose computer 102. Such a use of the resources and capabilities of the game console 104 may or may not require permission from a user at the game console 104.

In yet another possible scenario, a user experience being rendered at the game console 104 may be altered or affected at the multipurpose computer 102 using the interaction code 220 and the MC-side interaction code 212. In one exemplary scenario, the game console 104 may be rendering audio content. If the multipurpose computer 102 and the game console 104 are sharing resources, as described above, a user may be able to access the game console 104 from the multipurpose computer 102 and change the user experience being rendered at the game console 104. For instance, the user at the multipurpose computer 102 could change the volume of the audio content being played, or alternately, the user at the multipurpose computer 102 could view the audio selections available at the game console 104 and chose another song or selection to be rendered at the game console 104. In yet another aspect, the user at the multipurpose computer 102 could switch the user experience being rendered at the game console 104 from an audio experience to a video experience. In fact, the user at the multipurpose computer 102 could make any alterations to the user experience at the game console 104 that a user at the game console 104 might be able to implement. Interactions such as this may require permission from users, if any are present, at the game console 104.

In a similar fashion, a user at the game console 104 may be able to alter the user experience being rendered at the multipurpose computer 102. As above, the user at the game console 104 may require permission from any users at the multipurpose computer 102 before such changes to the user experience at the multipurpose computer 102 can be made.

### Abstracting Out Game Console and Multipurpose Computer Resources

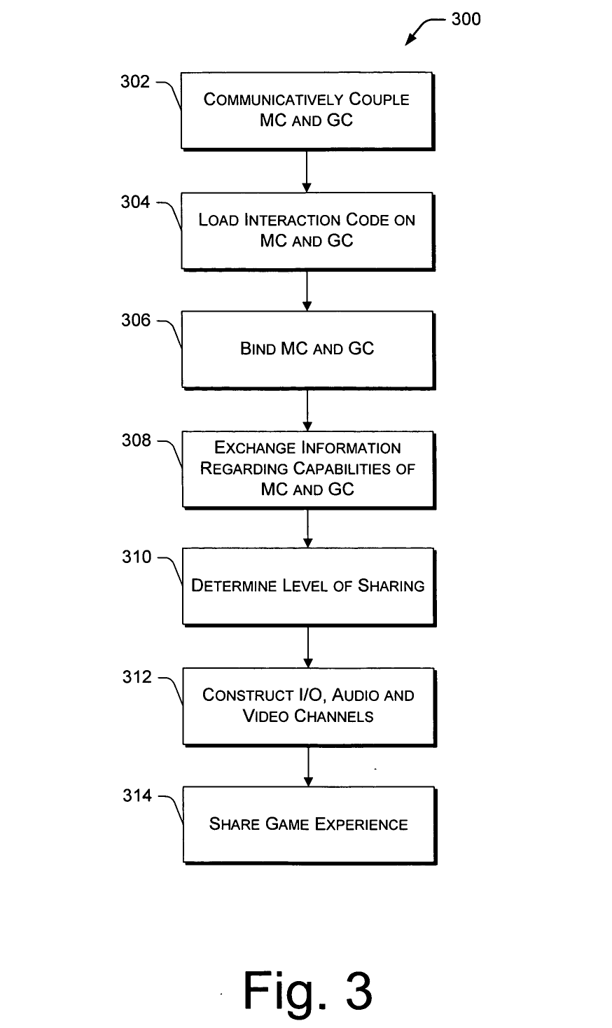

FIG. 3 illustrates an exemplary method 300 for abstracting out the resources and capabilities of both the game console 104 and the multipurpose computer 102 in order to enhance a user experience on the game console 104 and/or the multipurpose computer 102. For ease of understanding, the method 300 is delineated as separate steps represented as independent blocks in FIG. 3; however, these separately delineated steps should not be construed as necessarily order dependent in their performance. Additionally, for discussion purposes, the method 300 is described with reference to elements in FIGS. 1-2.

Block 302 comprises communicatively coupling the multipurpose computer 102 and the game console 104. This may be done using a network such as network 118 discussed above. In addition, MC-side interaction code 212 may be loaded onto the multipurpose computer 102, and interaction code 220 may be installed on the game console 104 (block 304). Both the MC-side interaction code 212 and the interaction code 220 may be loaded onto the multipurpose computer 102 and game console 104, respectively, by, for example, the manufacturer, another entity in the distribution channel from the manufacturer to the consumer, and/or by a user.

If desired, the game console 104, and the multipurpose computer 102 may also be bound together (block 306). This may be done to prevent the game console 104 and multipurpose computer 102 from communicating with every device to which they might be communicatively coupled. In one exemplary binding process, both the game console 104 and the multipurpose computer 102 may be provided with credentials identifying them as correct parties to undergo an abstraction of resources. Once these credentials are verified, the game console 104 and the multipurpose computer 102 may be bound.

After the multipurpose computer 102 and the game console 104 are bound, the game console 104 and the multipurpose computer 102 can begin to communicate and share resource information with each other in order to catalog resources and capabilities available on the multipurpose computer 102 and/or the game console 104 (block 308). For example, the multipurpose computer 102 and the game console 104 may report to each other what kinds of processor(s), memory, video cards, and input and output devices they possess.

Once the multipurpose computer 102 and the game console 104 have exchanged information regarding their available resources and capabilities, decisions can then be made as to how to best abstract those resources and capabilities and how to best leverage and share them (block 310). This may be done, for example, by the interaction code 220, the MC-side interaction code 212, and/or various other applications residing on the game console 104 and the multipurpose computer 102.

When an acceptable level of sharing has been determined, transmission channels, such as for example, channels for audio content, video content, and inputs and outputs may be established (block 312). These channels may be created using the lowest common denominators reported by the multipurpose computer 102 and the game console 104 regarding qualities such as acceptable bandwidth and processing speed in order to ensure a smooth flow of data and instructions through the transmission channels. It will also be understood that meta data may be used to transmit audio and video content between the multipurpose computer 102 and the game console 104. Such meta data could be interpreted by MC-side interaction code 212 on the multipurpose computer 102, and interaction code 220 on the game console 104 in order to render appropriate audio and video experiences.

For example, if the processing speed of the multipurpose computer 102 is inferior to that of the game console 104, then only a user experience which can be supported by the processing speed of the multipurpose computer 102 may be delivered to the multipurpose computer 102 over the network 118. Moreover, the characteristics of the network 118 itself may be considered. In some instances, a low bandwidth capacity of the network 118 may be the limiting factor in the interaction between the game console 104 and the multipurpose computer 102, preventing each from effectively sharing as many resources and capabilities as they have available.

Once channels for the audio content, video content, and inputs and outputs have been established, and appropriate resource and capability sharing levels have been established, the capabilities and resources of both the multipurpose computer 102 and the game console 104 may be leveraged (block 314). In one exemplary implementation, this may allow the game console 104 to use resources on the multipurpose computer 102, such as memory 208 and processor(s) 204, in order to enhance game play on the game console 104. In another exemplary implementation, leveraging the resources of the game console 104 and the multipurpose computer 102 may allow a user at the multipurpose computer 102 to play game titles on the game console 104 and otherwise manipulate the game console 104 in the same ways available to a user at the game console 104. Also, leveraging the resources of the game console 104 and the multipurpose computer 102 may allow the multipurpose computer 102 to share resources on the game console 104, such as memory 216 and processor(s) 214, in order to the user experience on the multipurpose computer 102.

### Method of Enhancing Game Play by Leveraging Resources at the Multipurpose Computer

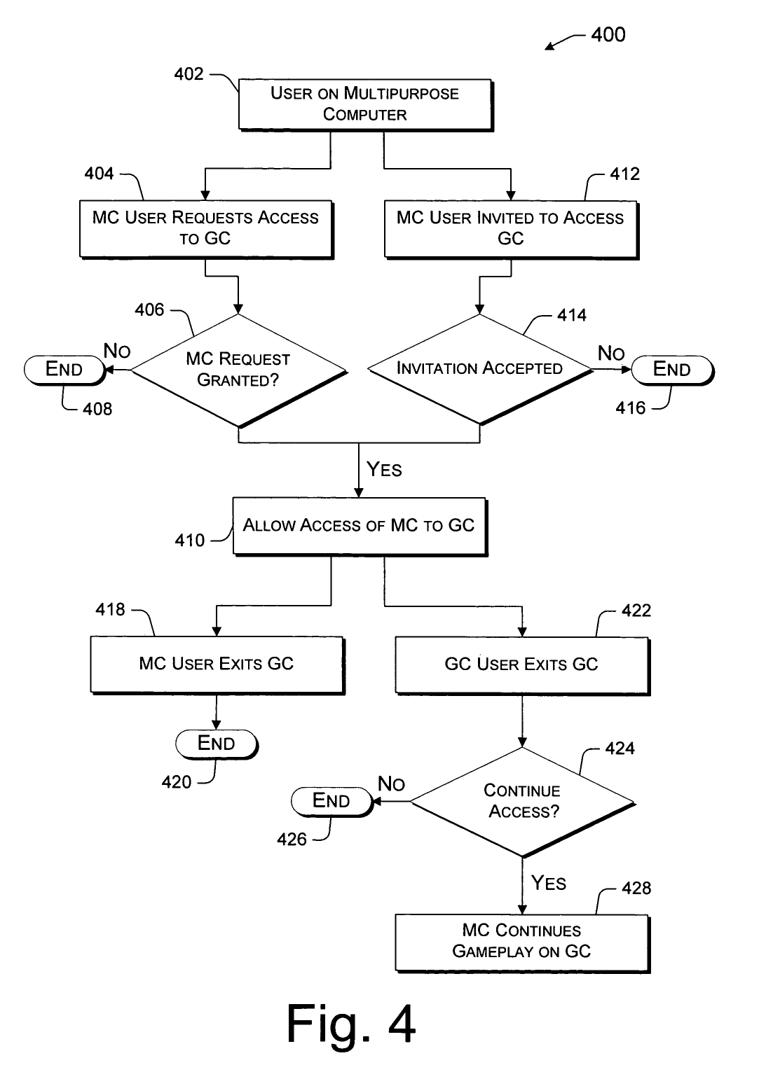

FIG. 4 illustrates an exemplary method 400 for enhancing game play at the game console 104 by leveraging resources at the multipurpose computer 102. For ease of understanding, the method 400 is delineated as separate steps represented as independent blocks in FIG. 4; however, these separately delineated steps should not be construed as necessarily order dependent in their performance. Additionally, for discussion purposes, the method 400 is described with reference to elements in FIGS. 1-2.

In one exemplary implementation, if the game console 104 and the multipurpose computer 102 are communicatively coupled—and sharing resources—the method 400 can begin at block 402 when a user is present at the multipurpose computer 102. The user at the multipurpose computer 102 may request access to play a game title on the game console 104 through the multipurpose computer 102 (block 404). In one exemplary configuration, a user at the game console 104 (if one is present) may elect to allow or decline access to the game console 104 (block 406). In the event that permission is declined (“no” path from block 406), the method 400 ends (block 408). Alternately, if the user at the game console 104 allows access, or if no permission is required to access the game console 104 (“yes” path from block 406), the user at the multipurpose computer 102 may be allowed to play the game title on the game console 104 (block 410).

Similarly, the user on the multipurpose computer 102 can be automatically invited to play a game title running on the game console 104, or alternately, a user on the game console (if one is present) may initiate an invitation to the user on the multipurpose computer 102 (block 412). The user on the multipurpose computer 102 may accept or decline this invitation (block 414). If the invitation is declined (“no” path from block 414), method 400 ends (block 416). If, however, the invitation is accepted by the user on the multipurpose computer 102, access is granted (“yes” path from block 414) and the user on the multipurpose computer 102 is allowed to play the game title on the game console 104 (block 410).

Once the user on the multipurpose computer 102 is satiated, or for other motivations desires to discontinue playing a game title on the game console, the user on the multipurpose computer 102 may exit from the game console (block 418), ending method 400 at block 420.

Alternately, the user on the game console 104 may decide to exit the game console (block 422). In such an instance the continued access of the user on the multipurpose computer 102 to the game console 104 may be reviewed (block 424). In one aspect, the user on the multipurpose computer 102 may not be allowed to access the game console 104 in the absence of a user at the game console 104. This will result in a revocation of right of the user on the multipurpose computer 102 to access the game console 104 (“no” path from block 424), which will end the method 400 at block 426, and kick the user at the multipurpose computer 102 off of the game console 104. Alternately, the user on the multipurpose computer 102 may be allowed to continue accessing the game console 104 (“yes” path from block 424), allowing for continued game play on the game console 104 (block 428).

It will also be understood, that method 400 described above may commence before the multipurpose computer 102 and the game console 104 are sharing resources. In such a scenario, the sharing of resources between the multipurpose computer 102 and game console 104 could be instigated only when needed. For example, in some instances sharing need not occur before the user at the multipurpose computer 102 is given permission to access to the game console 104 (block 410).

### Method of Enhancing Game Console by Leveraging Resources at the Multipurpose Computer

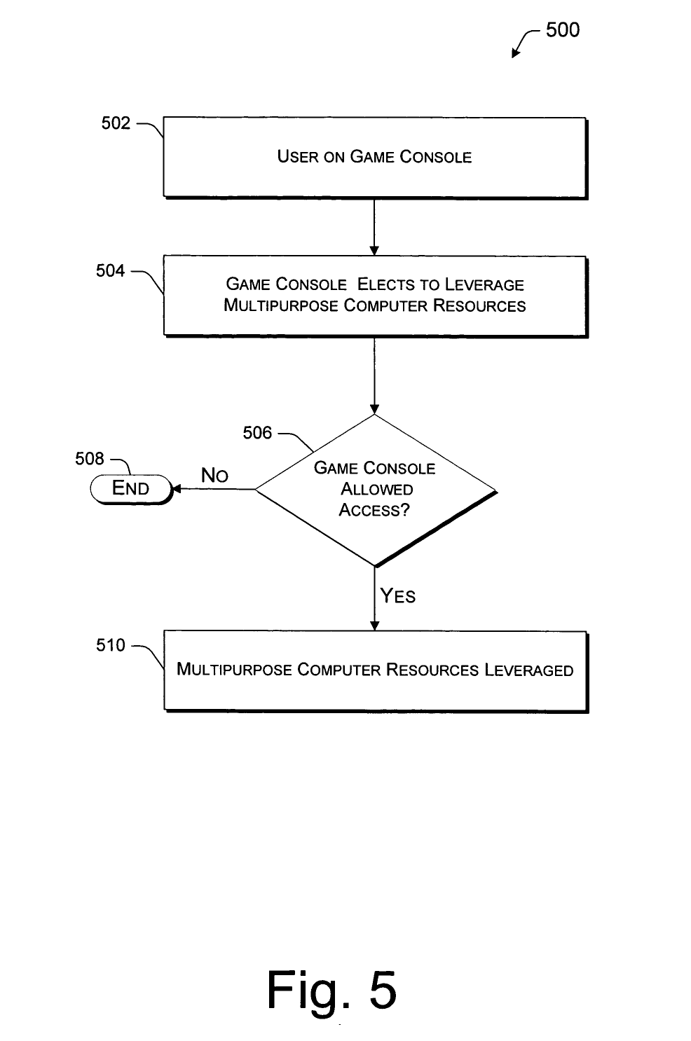

FIG. 5 illustrates an exemplary method 500 for enhancing the game console 104 by leveraging resources at the multipurpose computer 102. For ease of understanding, the method 500 is delineated as separate steps represented as independent blocks in FIG. 5; however, these separately delineated steps should not be construed as necessarily order dependent in their performance. Additionally, for discussion purposes, the method 500 is described with reference to elements in FIGS. 1-2.

In one exemplary implementation, if the game console 104 and the multipurpose computer 102 are communicatively coupled—and sharing resources—the method 500 can begin at block 502 when a user is present at the game console 104. For a variety of reasons, it may be desirable to elect to leverage the resources and capabilities of the multipurpose computer 102 in order to enhance the capabilities of the game console 104. For instance, several users may be playing a complex game title at the game console 104 which requires more memory and processing resources than might be available at the game console 104. In such an instance, the users might initiate an election to leverage the resources of the multipurpose computer 102 (block 504). Alternately, the game console 104 itself could initiate block 504 once the usage of resources on the game console 104 approaches the capacity of the resources available on the game console 104.

Such a request may be subject to permission granted by a user on the multipurpose computer 102 (block 506). Alternately, the request may be subject only to availability of resources on the multipurpose computer 102. If access is denied (“no” path from block 506)—for example, either by the user on the multipurpose computer 102 denying permission, or by the multipurpose computer 102 itself due to lack of available resources to be shared—then the method 500 is ended (block 508) and no resource sharing occurs between the game console 104 and the multipurpose computer 102. If, however, access is granted by the user of the multipurpose computer 102, or the multipurpose computer 102 itself (“yes” path from block 506), then the game console 104 is allowed to leverage the resources of the multipurpose computer 102 (block 510). This may include the game console 104 using resources such as memory and processing power on the multipurpose computer 102 in order to improve the user experience rendered at the game console 104.

The game console 104 may leverage the processing power of the multipurpose computer 102 in several ways. For example, code native to the processor 204 may be utilized by the game console 104 in order to leverage native execution of the processor 204. The game console 104 could also leverage the processor by utilizing an intermediate code language, which could be translated into the native code of the processor 204 through use of common runtimes running natively on the processor 204. Moreover, it will be understood that the method used to leverage the processor 204 may depend on the functionality that is desired from the processor 204.

In one exemplary implementation, the resources on the multipurpose computer 102 could be used to enhance the complex game title being played by users at the game console 104. For example, the game title being played on the game console 104 could use processing power from the multipurpose computer 102 to implement or enhance the artificial intelligence for some characters in the game title.

It will also be understood that in a similar manner, the situation in method 500 could be reversed, and a user at the multipurpose computer 102, could leverage resources on the game console 104 in order to improve a user experience being rendered at the multipurpose computer 102.

As with method 400 discussed above, method 500 may commence before the multipurpose computer 102 and the game console 104 are sharing resources. In such a scenario, the sharing of resources between the multipurpose computer 102 and game console 104 could be instigated only when needed. For example, sharing of resources and capabilities between the game console 104 and multipurpose computer 102 could be delayed until the game console 104 is allowed access to the resources and capabilities of the multipurpose computer 102 (block 510).

### Method of Interacting with the Game Console through the Multipurpose Computer

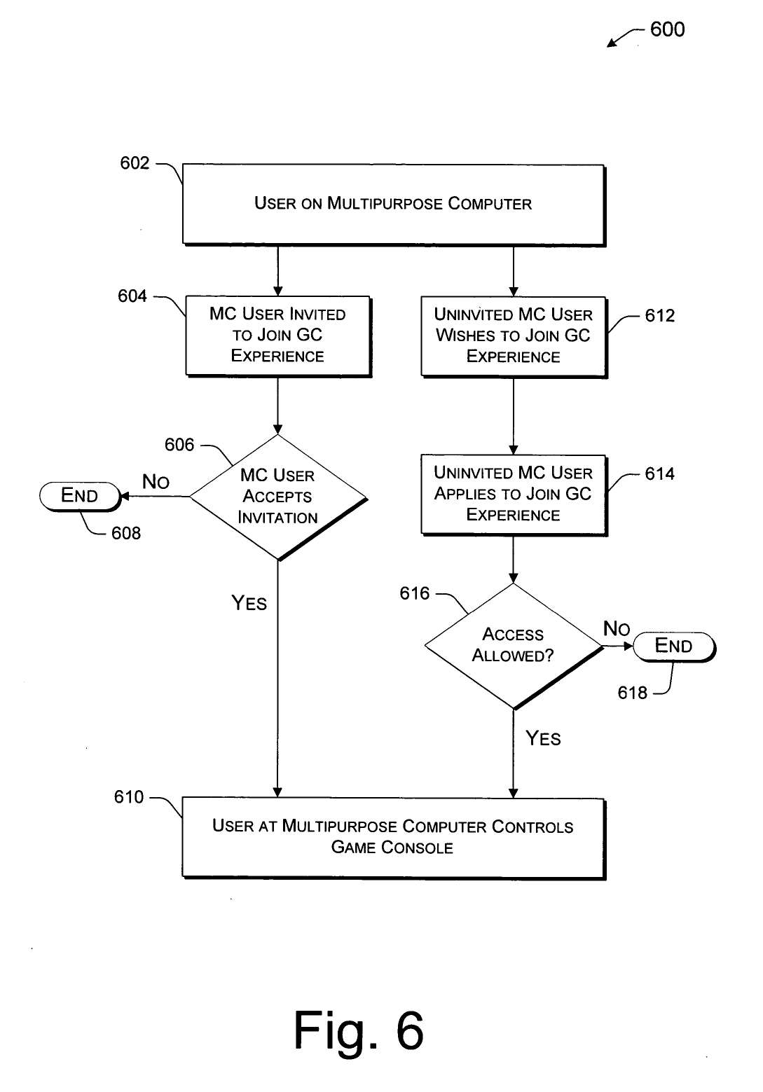

FIG. 6 illustrates an exemplary method 600 for interacting with the game console 104 through the multipurpose computer 102. For ease of understanding, the method 600 is delineated as separate steps represented as independent blocks in FIG. 6; however, these separately delineated steps should not be construed as necessarily order dependent in their performance. Additionally, for discussion purposes, the method 600 is described with reference to elements in FIGS. 1-2.

In one exemplary implementation, if the game console 104 and the multipurpose computer 102 are communicatively coupled—and sharing resources—the method 600 can begin at block 602 when a user is present at the multipurpose computer 102. The user at the multipurpose computer 102 may be issued a prompt at the multipurpose computer 102 giving them the status of the game console 104 and/or inviting them to join the user experience at the game console 104 (block 604). For example, the user may be informed that the game console 104 is playing audio content from a particular collection of MP3 media files.

The user at the multipurpose computer 102 may then be given the choice of accepting or declining an invitation to join the user experience at the game console 104 (block 606). If the user declines (“no” path from block 606), the method 600 ends (block 608), and the user continues their user experience at the multipurpose computer 102. Alternately, however, if the user accepts the invitation (“yes” path from block 606), the user at the multipurpose computer 102 may be allowed to access the game console 104 and manipulate the game console 104 in the same ways a user at the game console 104 could (block 610). The only difference being that the user at the multipurpose computer 102 may manipulate the game console from the multipurpose computer 102 using the input devices available at the multipurpose computer 102. Continuing the example from above, the user at the multipurpose computer 102 may choose to turn off the game console 104 from the multipurpose computer 102, or alternately the user at the multipurpose computer 102 may choose to change the content being rendered on the game console (for example, choose from a variety of MP3 files available to the game console 104) or have the content being rendered on the game console 104 also be rendered by the multipurpose computer 102.

In another aspect of method 600, the user at the multipurpose computer 102 may try to access the game console 104 without being invited to do so. For example, the user may independently desire to access the game console (block 612). Perhaps the user hears the game console rendering media content in another room and wants the operation to stop. Or, perhaps the user wishes to access the game console 104 and change the media content being rendered. In any event, the user at the multipurpose computer 102 may apply to gain access to the game console (block 614). This request may be reviewed and either accepted or declined (block 616). For example, in the event that resources are near capacity on either the multipurpose computer 102 or the game console 104, and access would deleteriously affect the user experience at either the multipurpose computer 102 or the game console 104, the users request may be denied (“no” path from block 616). Alternately, the request of the user at the multipurpose computer 102 may be reviewed by user(s) at the game console 104, and a decision made there as to whether to allow or deny the user at the multipurpose computer 102 access to the game console 104. If the request is denied (“no” path from block 616), the method 600 ends (block 618) and the user at the multipurpose computer 102 is relegated to continuing their user experience at the multipurpose computer 102.

If, however, resources at the multipurpose computer 102 and the game console 104 are sufficient to allow the user at the multipurpose computer 102 to access the game console 104 (or the users at the game console 104 consent to allow the user at the multipurpose computer 102 access to the game console 104) (“yes” path from block 616), then the user at the multipurpose computer 102 may be given access to the game console 104 from the multipurpose computer 102 (block 610).

As with methods 400 and 500 discussed above, it will be understood that method 600 may commence before the multipurpose computer 102 and the game console 104 are sharing resources. For example, the instigation of resource and capability sharing between the multipurpose computer 102 and game console 104 may be delayed until the user at the multipurpose computer 102 actually begins controlling the game console from the multipurpose computer 102 (block 610).

1. A game console comprising:
one or more controllers that are operable by a user to manipulate media content displayed on a graphics display;
a communications port configured to receive inputs from a multipurpose computer;
wherein the game console is configured to allow media content displayed on the graphics display to be manipulated with the inputs from the multipurpose computer.

2. The game console of claim 1, wherein the game console is further configured to enable a first player on the multipurpose computer and a second player on the game console to simultaneously play a game that is executing on one or more of the game console and the multipurpose computer.

3. The game console of claim 2, wherein the first player receives a full screen rendering of the game on a monitor coupled to the multipurpose computer, and the second player receives a full screen rendering of the game on the graphics display.

4. The game console of claim 1, wherein a first player on the multipurpose computer is enabled to alter a media experience being rendered by the game console.

5. The game console of claim 1, wherein the game console is further configured to give a second player on the game console the option to give a first player on the multipurpose computer the option to play a game executing on the game console.

6. The game console of claim 1, wherein the game console and the multipurpose computer share resources to enhance a media experience being rendered at one or more of the game console and the multipurpose computer.

7. One or more computer-readable media having computer-readable instructions that, when executed, perform acts comprising:
communicating between a game console and a multipurpose computer;
cataloging resources and capabilities available on at least one of the game console and the multipurpose computer;
sharing said resources and capabilities between the game console and the multipurpose computer.

8. The one or more computer-readable media as recited in claim 7, the acts further comprising verifying credentials by at least one of the multipurpose computer and the game console before allowing the multipurpose computer and the game console to communicate.

9. The one or more computer-readable media as recited in claim 7, wherein the computer-readable instructions implement a game.

10. The one or more computer-readable media as recited in claim 7, wherein the catalogued resources and capabilities comprise one or more of the following:
processor characteristics, memory characteristics, amounts of available memory, video card characteristics, possible bandwidth of data that can be effectively handled by a video card, possible bandwidth of data that can be effectively handled by a network interface, and input and output devices available.

11. The one or more computer-readable media as recited in claim 7, the acts further comprising constructing one or more transmission channels coupling the game console and the multipurpose computer, the transmission channels including at least one of an input/output channel, an audio channel, and a video channel.

12. The one or more computer-readable media as recited in claim 7, wherein the computer-readable instructions are part of an operating system.

13. The one or more computer-readable media as recited in claim 7, the acts further comprising prompting a user at the game console to grant permission to a user at the multipurpose computer to join a game being executed on the game console.

14. A method, comprising:
preparing a first report of resources and capabilities available on a game console;
preparing a second report of resources and capabilities available on a multipurpose computer;
examining the first and second reports to determine a possible level of sharing of resources and capabilities between the game console and the multipurpose computer; and
sharing at least some of said resources and capabilities between the game console and the multipurpose computer.

15. The method of claim 14, further comprising constructing transmission channels coupling the game console and the multipurpose computer.

16. The method of claim 14, further comprising configuring the game console to accept inputs from the multipurpose computer, wherein the inputs at least partially control the game console.

17. The method of claim 14, further comprising using resources and capabilities of the multipurpose computer to improve a media experience being rendered by the game console.

18. The method of claim 14, wherein sharing at least some of said resources and capabilities between the game console and the multipurpose computer is contingent on permission granted from at least one of a user on the game console and a user on the multipurpose computer.

19. The method of claim 14, further comprising prompting a user on the multipurpose computer to participate in game play on the game console.

20. The method of claim 14, wherein the resources and capabilities comprise at least one of the following:
characteristics of a processor, characteristics of memory, characteristics of a network, amounts of available memory, characteristics of a video card, characteristics of a network, possible bandwidth of data that can be effectively handled by the video card, possible bandwidth of data that can be effectively handled by a network interface, and input and output devices available.
